(19) United States
(12) Patent Application Publication
(10) Pub. No.: US 2011/0125632 A1
(43) Pub. Date: May 26, 2011

(54) Consumer Direct Loan Qualification System And Method For Submitting Loan Applications

(75) Inventor: Gerald A. Neel, Irvine, CA (US)

(73) Assignee: MORTGAGESOFT CORPORATION, Irvine, CA (US)

(21) Appl. No.: 12/953,211

(22) Filed: Nov. 23, 2010

Related U.S. Application Data
(60) Provisional application No. 61/263,688, filed on Nov. 23, 2009.

(51) Int. Cl. G06Q 40/00

(52) U.S. Cl. 705/38

(57) ABSTRACT

A consumer direct loan qualification system and method is accessed from a borrowers' computer system. The loan qualification system communicates with a server computer that hosts an automated underwriting entity. The automated underwriting entity is further coupled to a network of lender computers enabling a borrower to apply for mortgage financing by facilitating the qualification, underwriting and submission of loan application files directly to lenders.

### RELATED APPLICATION

This application claims the benefit of U.S. Patent Application Ser. No. 61/263,688 filed on Nov. 23, 2009, the entirety of which is hereby incorporated by reference.

### BACKGROUND

The mortgage lending process has become significantly more complex since the days when a borrower and lender met face-to-face to arrange financing for the purchase of a home or to refinance an existing mortgage. Previously, the process was very subjective, and significant weight was given to the relationship between the borrower and lender. It was not uncommon for the deal to be affirmed in the form of a handshake.

With technological progress, the lending process has become less personal and increasingly complex and opaque to the borrower. The World Wide Web created a massive information portal making the potential for a borrower to engage in on-line comparison shopping for a mortgage. In fact, a group of websites has emerged which purports to cause lenders to compete with each other for loans. However, the existing system makes it virtually impossible for a borrower to know if she or he could qualify for better terms than those presented by the broker for the loan.

With the advent of on-line services and web-based systems, various computer software applications commonly referred to as “tools” were developed to assist mortgage brokers in the loan process. One such tool, referred to as Loan Origination Software (LOS), has evolved. Although these software systems have been developed to facilitate lending procedures between brokers and lenders, there is presently no end user version for borrowers to directly participate in the loan process. The mortgage industry has been slow to empower borrowers with the tools to save them time and money and to help them choose the best available loan options.

Current LOS systems are not true collaboration tools for borrowers because these systems were designed almost exclusively for loan officers, loan processors, and mortgage brokers and do not satisfactorily address real borrower needs. Because of this, borrowers presently cannot easily access complete reliable information and frequently do not achieve the most favorable rates and terms.

### SUMMARY

This disclosure is generally directed to a loan qualification software system allowing borrowers to complete and submit mortgage loan applications to lenders with no mortgage broker assistance. Loan qualification occurs on or through the borrower's computer.

In some examples, the loan qualification system resides on or is accessed through a borrower's computer and includes a loan qualification software program integrated with a desktop or web-browser based client user interface system. The client user interface system couples the loan qualification software program to one or more server computers. The server computers are further coupled to an online network of lenders enabling the borrower computers to communicate with the lenders computers.

A module on the borrower computer securely stores personal loan application data related to the borrower for on-line submission to the automated underwriting engine coupled to the server for evaluation and loan approval consideration. If approved by the underwriting system, the borrower is then presented with a list of lenders from which to choose. The borrower then picks a lender and the loan qualification system couples the borrower to the lender for further fulfillment.

The system includes a loan product suggestion feature. This feature, which guides the borrower in a step by step method by asking a series of questions, suggests alternatives and allows the borrower to choose a loan product based on the answers provided by the borrower. The system also includes an integrated help management module, enabling borrowers to facilitate the completion of the loan application providing explanation pertaining to a field of the of the loan application being populated. These features have the option of being toggled on or off.

In one aspect, a computer-based system is provided for borrowers to complete a standard residential 1003 loan application form, order credit reports from the three credit bureaus, submit the relevant loan application data to an underwriting entity for evaluation and approval consideration, upon approval, connect directly to the lender of choice within a list of lenders approving the borrower based on the decision of the automated underwriting entity.

Other features and advantages will be apparent from the accompanying drawings and from the detailed description that follows below, wherein the detailed description is for the purpose of fully disclosing preferred embodiments without placing limitations thereon.

### DESCRIPTION OF THE DRAWINGS

The present disclosure is illustrated by way of example and not limitation in the figures of the accompanying drawings, in which like references indicate similar elements, and in which:

FIG. 1 presents a computer system implementation capable of carrying out the functionality of one embodiment of the current disclosure;

FIG. 2 illustrates a network that implements a loan origination and processing software system;

FIG. 3 is a block diagram that illustrates the interface between the borrower computers and the loan origination server;

FIG. 4 is a flowchart illustrating the steps of processing and submitting a loan application through a loan application processing and submission system;

FIG. 5 is an exemplary screen shot of the borrower interface page;

FIG. 6 is an exemplary screen shot for a loan application referenced in the interface page of FIG. 5;

FIG. 7 illustrates an exemplary credit screen shot for a report returned from a credit reporting agency;

FIG. 8 is an exemplary screen shot of the help feature within the borrower interface page;

FIG. 9 is an exemplary screen shot of the list of lenders that have approved the borrower for mortgage financing through the automated underwriting engine; and

FIG. 10 is another flowchart illustrating the steps of processing and submitting a loan application through a loan application processing and submission system.

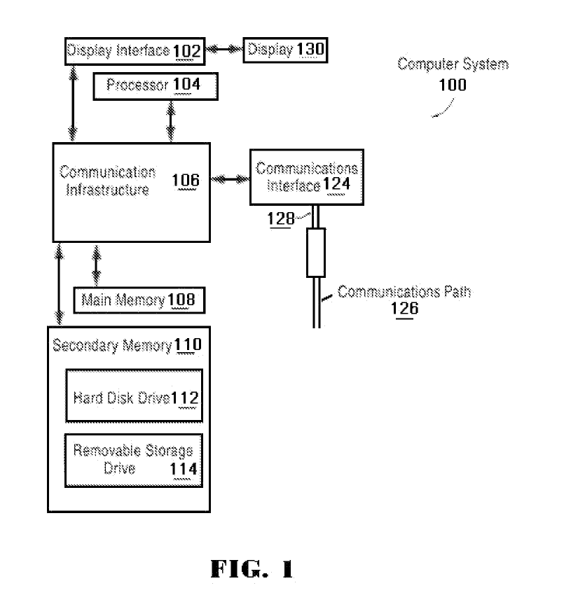

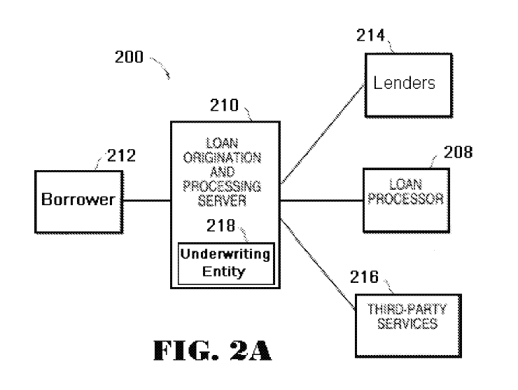

### DETAILED DESCRIPTION

Various software embodiments are described in terms of this exemplary computer system. After reading this description, it will become apparent to a person skilled in the relevant art(s) how to implement the disclosure using other computer systems and/or architectures.

Computer system 100 includes one or more processors, such as processor 104. The processor 104 is connected to a communication infrastructure 106. Computer system 100 includes a user interface 102 that forwards graphics, text, and other data from the communication infrastructure 106 for display on a display unit 130.

Computer system 100 includes a main memory (RAM) 108, and also includes a secondary memory 110. The secondary memory 110 includes a hard disk drive 112 and a removable storage drive 114 such as a CD ROM.

Computer system 100 also includes a communications interface 124. Communications interface 124 allows software and data to be transferred between computer system 100 and external devices. Examples of communications interface 124 may include a modem, a network interface (such as an Ethernet card), and a communications port. Software and data transferred via communications interface 124 are in the form of signals 128, which may be electronic, electromagnetic, optical or other signals capable of being received by communications interface 124. These signals 128 are provided to communications interface 124 via a communications path (e.g., channel) 126. This path 126 carries signals 128 and may be implemented using wire or cable, fiber optics, a telephone line, a cellular link, a radio frequency (RF) link and/or other communications channels. In this specification, the terms “computer program medium” and “computer usable medium” are used to refer generally to media such as a removable storage drive 114, and a hard disk installed in hard disk drive 112, and signals 128 received by communications interface 124.

The computer program is stored in main memory 108 and/or secondary memory 110. The computer program may also be received via communications interface 124. Such computer programs, when executed, enable the computer system 100 to perform the features of the present disclosure, as discussed herein. In particular, the computer programs, when executed, enable the processor 104 to perform the features of the present disclosure. Accordingly, such computer programs represent controllers of the computer system 100.

This disclosure is implemented using software loaded into computer system 100 using removable storage drive 114, hard disk drive 112, or communications interface 124. The control logic (software), when executed by the processor 104, causes the processor 104 to perform the functions of the disclosure as described herein.

A comprehensive and integrated loan origination software system for use by borrowers seeking mortgage financing is disclosed. In the following description, for purposes of explanation, numerous specific details are set forth in order to provide a thorough understanding of the present disclosure. It will be evident, to one of ordinary skill in the art, that the present disclosure may be practiced without these specific details. In other instances, known structures and devices are shown in block diagram form to facilitate explanation. The description of preferred embodiments is not intended to limit the scope of the claims appended hereto.

Aspects of the present disclosure may be implemented on one or more computers executing software instructions. According to one embodiment of the present disclosure, server and client computer systems transmit and receive data over a computer network or a fiber or copper-based telecommunications network. The steps of accessing, downloading, and manipulating the data, and other aspects of the present disclosure are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present disclosure.

Aspects of the present disclosure can be used in a distributed electronic application that includes a client/server network system that links one or more server computers to one or more client computers, and server computers to other server computers. The client and server computers may be implemented as desktop personal computers, workstation computers, mobile computers, portable computing devices, personal digital assistant (PDA) devices, or any other similar type of computing device.

In the loan application process, a borrower chooses a loan product that best suits his or her needs. In the retail loan market, a borrower directly inquires about loans available from lenders that typically have in house processors. Wholesale lenders, typically offer discounted pricing in return for the processing work performed by a loan processor, and take the completed loan packages and underwrite them.

In a network embodiment of the present disclosure, a borrower's computer is configured to access computers operated by third parties, such as lenders, loan processors and other similar service providers through a web based interface that is integrated with a loan origination software program. The loan origination software provides an interface to those companies that will ultimately perform the loan services and provide the requested funds. During the course of the loan application process, various items of information are transmitted among the parties, including borrower information and loan application data. This information is typically maintained in databases stored in the borrower computer, or on the third party computers.

The network implementation facilitates the delivery (transmission) and tracking of data and allows for the completion of electronic commerce transactions. Several different network topologies may be implemented through the use of a loan processing network system according to embodiments of the present disclosure. In general, the network system couples one or more potential borrowers' to one or more lenders. The borrowers search for compatible loans from various lenders by performing certain loan origination tasks, such as completing the loan application and pre-qualification steps then submitting personal data to the underwriting engine of the interactive loan origination and processing server, through the networked interface that the loan origination software provides. The borrowers also directly interface with the parties that will fulfill the loan or provide settlement services, such as lenders and third party service providers.

For purposes of the present discussion, a loan broker is any person or entity that, acting in the capacity of an intermediary, helps to procure a loan on behalf of a borrower.

For purposes of the present discussion, a loan originator is a borrower or any person seeking to acquire a mortgage for them self.

For purposes of the present discussion, “potential borrower,” “borrower” and “borrowers” are used interchangeably herein to describe any person seeking to acquire a mortgage.

For the purposes of the present discussion, “Lenders” include banks, investment companies, real estate lenders, investment and holding companies, and any commercial entity engaged in the business of financing loans or mortgages.

System Overview

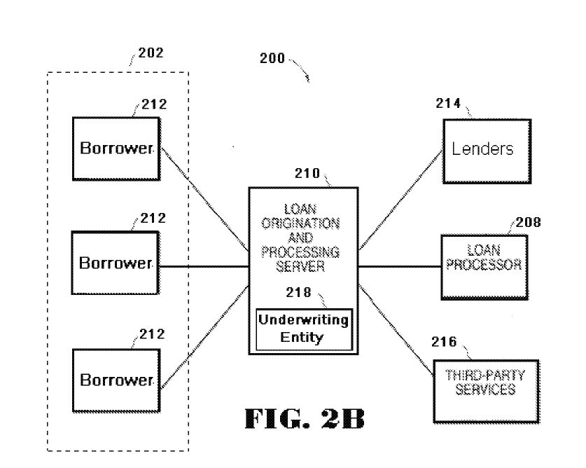

In one embodiment of the present disclosure, the loan origination software system and database are executed and maintained on a standalone computer that is coupled to an interactive server operated by the software provider. FIG. 2 illustrates an exemplary network system for processing loan applications, according to one embodiment of the present disclosure. In system 200, a borrowers' stand alone computer 212 executes a LOS program and maintains a database that stores relevant borrower data, and other data, such as other mortgage or general loan-related information. The LOS program computer comprises several program modules that manage the loan origination process.

As illustrated in FIG. 2a, the borrowers' stand alone computer 212 executes a LOS program. In an alternative embodiment, as illustrated in FIG. 2b, a computer 212 within the borrower computer network 202 executes a standalone LOS program of the same LOS program and maintains databases that store relevant borrower data and other data pertinent to the loan application process.

The loan origination and processing server 210 is coupled to a borrower computer network 202. For purposes of the present discussion, the borrower computer network 202 consists of three different functional borrower computers which represent the plurality of borrowers within the borrower computer network. Each functional block in system 200 is intended to represent a networked computer that is operated by a respective operator.

The computer 212 generally performs the function of completing the loan application. The loan underwriting entity 218 reviews the loan application and approves or denies the application. The settlement service vendors 216 provide services and information to close the loan. Such vendors include appraisers, credit bureaus and the like.

System 200 includes a network interface that provides access between the loan origination and processing server 210 and other entities. For this embodiment, as illustrated in FIG. 2, the lender 214, settlement service vendors 216, and loan processor 208 are coupled to the loan origination and processing server 210. The processing server 210 then provides the communication link between these entities and the various parties within the borrower computer network 202. In a typical implementation, the network coupling the various computers comprises the Internet, and the interface for a user may be a web-based interface. In this case, a functional block executes a web browser client process.

The borrower computers within borrower computer network 202 can be networked computers coupled to the server over a LAN, WAN, or similar network system, or they can be connected through the Internet. Furthermore, one or more of the computers can be remote or mobile devices that are periodically coupled to the server.

The processing system of 200 includes modules that serve to update system files from processing server 210 to borrower computers of the borrower computer network 202, present a software update option, and perform the update of the loan origination system on demand.

The processing system illustrated in system 200 can use the Secure Sockets Layer (SSL) protocol when transmitting data between borrower computer network 202 and processing server 210. The transfer of data between borrower computers of the borrower computer network and the processing server 210 is based on an open and expandable file format not restricting or limiting the type or amount of data. As stated above, the borrower-side of the system 200 can be implemented through a web browser over an Internet link.

Loan Origination System Process

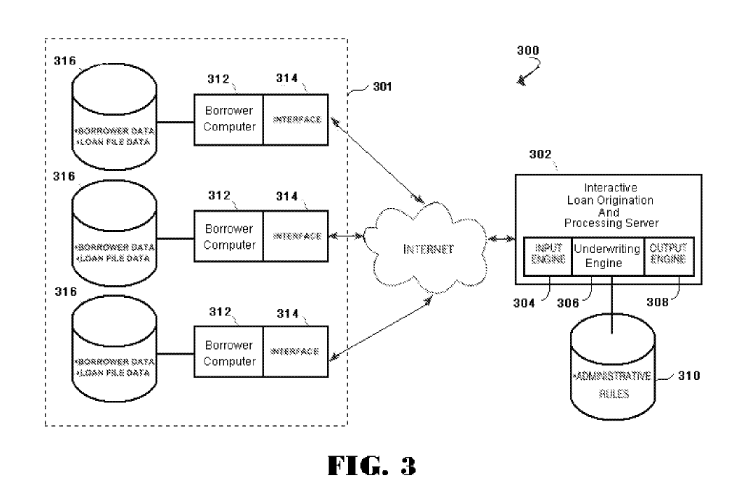

As illustrated in FIG. 2, the loan origination software system is provided in a borrower's stand alone computer and data relating to the borrower is stored in a secure database residing on the borrowers' computer. The borrower computer network 202 interfaces to the loan origination and processing server 210 through separate physical interfaces for each of the borrowers' computers within the borrower computer network. FIG. 3 is a block diagram that illustrates the interface between the borrower computers of the borrower computer network and the loan origination server, according to one embodiment of the present disclosure.

As illustrated in system 300, the loan origination and processing server 302 is coupled to a borrower computer network 301 comprising borrower client computer 312 through interface 314. The borrower client computer 312 is also coupled to a database 316, which allows data to be stored locally for the borrower computers thus; the borrower client computer 312 can maintain a database 316 which includes borrower financial and identification data, loan application data, and so on. The loan origination and processing server 302 is also coupled to a database 310, which is the centralized data store for common or shared software updates related to the loan origination system resident on borrower computers.

The loan origination and processing server 302 executes an LOS program that includes several modules including an input engine 304, an underwriting engine 206, and an output engine 308. The input and output engines 304 and 308 control the flow of data and processing instructions between the processing server 302 and the computer 212, and any other client computers that may be coupled to processing server 302. The underwriting engine includes processing and program modules within the loan origination program that perform calculations and translate the complex business rule and calculation procedures into a readable format by the borrowers.

In one embodiment, the processing and submission system illustrated in FIG. 3 includes help file templates that are utilized during loan origination. This allows for relevant loan application information to be displayed in a popup format while a borrower is entering information into a field of the loan application. An automatic help feature process from the origination screen explains a field being populated by the borrower. This automatic help feature reduces mistakes in the application process.

Once information is entered into the data fields, e.g., name and address, of the file template during the loan origination process, the information is saved in database 316, wherein a data field is associated with the particular information entered. In one embodiment, the database may be saved in the data storage facility coupled to or included within the borrower client computer 312.

The loan origination system program can be configured to export loan data to different popular formats such as Freddie Mac, Fannie Mae, and other proprietary formats. Once the loan data has been exported, it can easily be submitted to other third parties, such as lender 214.

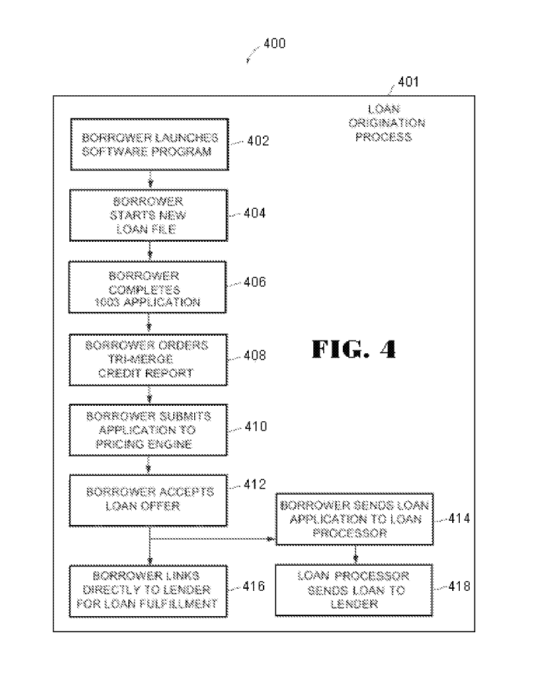

FIG. 4 is a flowchart 400 that illustrates the steps undertaken by the loan originator, for a loan application processed by the system of FIG. 3, according to a method of the present disclosure. The computer 212 is launched and first causes the display of the loan application on the borrower computer, step 402. This is typically a standard residential 1003 mortgage application displayed on the loan originator client computer.

The loan origination process start with the initiation of a new loan file, step 404. The borrower first enters relevant information for borrower and co-borrower, step 406. Once initial information is entered, the borrower orders a credit report(s), typically through a third-party credit reporting agency, step 408. Using their financial information and credit score, the borrower can attempt to pre-qualify using an underwriting process, step 410. In step 412, the borrower accepts a loan approval consideration and submits the loan application documents to the lender 416 for loan fulfillment. In step 414, the borrower accepts a loan approval consideration and submits the loan application documents to the loan processor. In step 418, the loan processor receives the loan file from the borrower and submits the processed file to the lender for loan fulfillment.

In one embodiment of the present disclosure, a loan application is populated with borrower and lender information, and is passed on to a loan processor for further processing. In step 418, the processor contacts the loan originator who initiated the loan application to contract the processing of the loan application and coordinate further steps to fulfill the loan processing step of the mortgage financing procedure. Once a loan application is sufficiently mature, the processor submits the loan to a lender for funding.

The current status of a loan application is stored in database 310. If a new status report is available it is sent to the borrower computer when the borrower executes the LOS and launches the web browser.

Borrower Interface

The task of the borrower is basically to initiate the loan application process by completing the standard residential loan application, ordering credit and submitting the loan file to the underwriting engine for evaluation.

The interface enables the compiling of data by the borrower for pre-qualification and facilitates the development of borrower/lender relationships. The interface provides instant status display of the loan file, and displays auto alerts indicating the presence of any issues the borrower needs to address such as submission of further application documents.

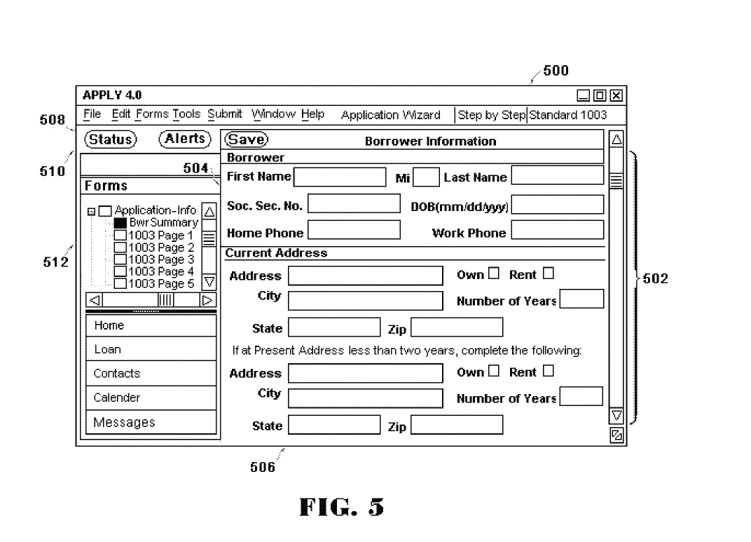

FIG. 5 is an exemplary screen shot of the borrower interface page, according to one embodiment of the present disclosure. The borrower interface page 500 includes a loan application section 502 that displays the currently loan application in the system. The loan application is specified by borrower name 504 with various entry points for loan information and type 506, status 508, alerts section 510 and application pages 512. The alerts section 510 contains visual alerts, to alert the viewer to items of the loan application needing immediate attention.

FIG. 5 illustrates an embodiment of the interface for the loan submission and processing system. This interface is implemented in such a way that information displayed facilitates the goals and needs of the borrower by providing easy access to common functions and displaying relevant information. Certain tools and functionalities for use outside the loan file and are made available in the “Tools” interface.

In one embodiment, the main display interface shown in borrower interface page 500 includes a tabbed display feature that allows access to other significant tools and interfaces within the processing server 210. As shown in FIG. 5, the application interface is accessible under the tab labeled “Loans.” Similarly other tools, information, and interfaces can be accessed through the other tabs. For example, the “contacts” tab provides access to an integrated contact manager, the “Settings” tab allows the user to modify certain parameters regarding the organization and presentation of the data within the system, the “Reports” tab provides for the generation of various reports based on the data stored within the system, and the “Dashboard” tab provides for customized viewing of data. Functionality regarding these alternate interfaces will be described in greater detail below.

Within the borrower interface page 500, detailed information regarding a loan application can be accessed or input by selecting the loan application in the loan application section 502.

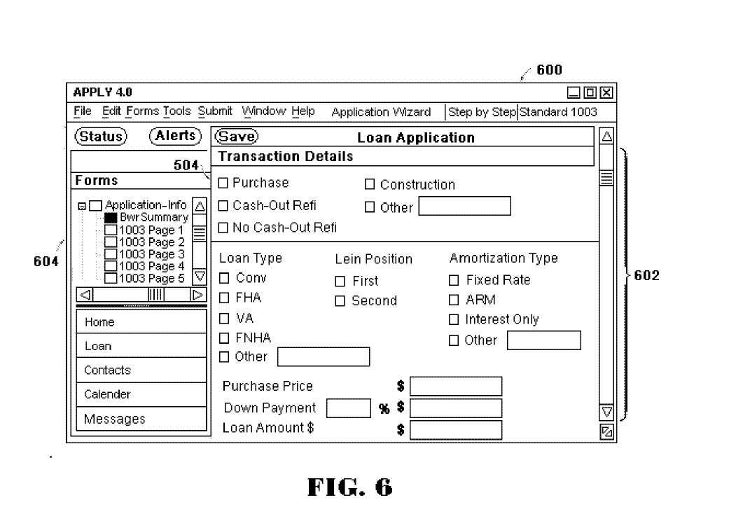

FIG. 6 is an exemplary screen shot for a loan application referenced in the interface page of FIG. 5. Selecting the loan application causes the display of a transaction details window 602. This window provides various user input fields for the entry of data related to the loan and the subject property, as shown. A forms sub-window 604 provides access to relevant forms that can be generated and printed or transmitted to the lender.

The interface 314 is also configured to provide direct access to lenders and third party service provides for online ordering of credit reports, pre qualifications, and similar external functions.

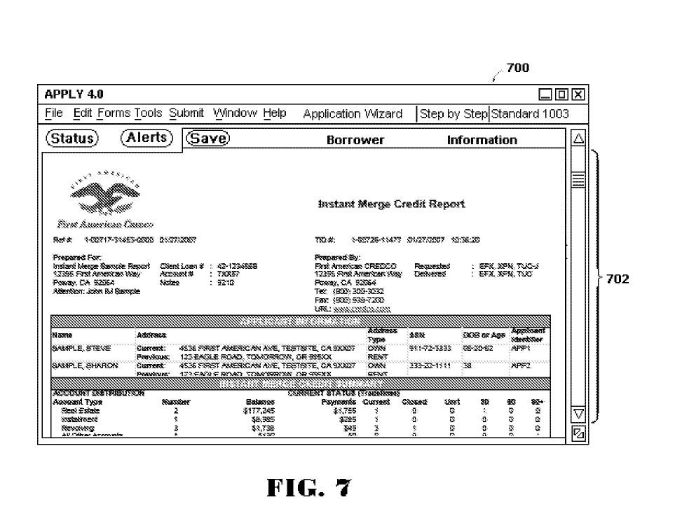

FIG. 7 illustrates an exemplary loan credit report returned from a credit reporting agency through the borrower user interface. The data illustrated in screen window 702 is displayed as provided in simple text form by the credit reporting agency. It can be formatted in any manner desired by the user. Upon submission of the credit report request, relevant data regarding the borrower and the loan is transmitted from the database 316 to the credit reporting agency. Other third party service providers can be accessed in a similar manner.

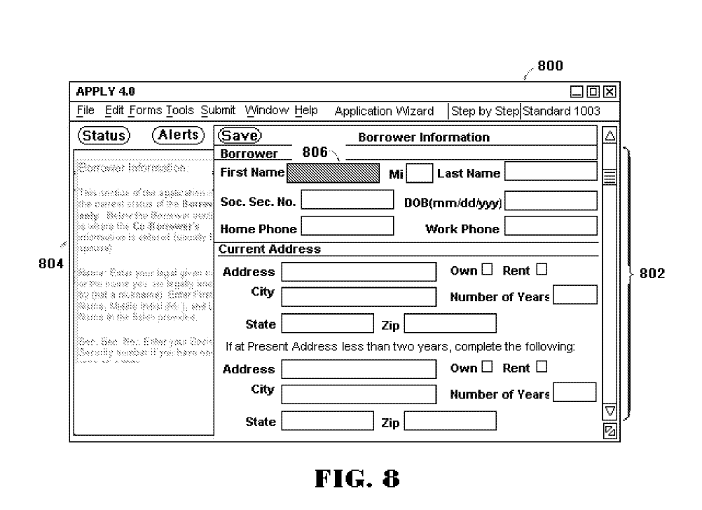

FIG. 8 illustrates an embodiment of the interface for the loan application process. This interface is implemented in such a way that a help feature is displayed to the left of the screen to facilitate the loan application process by explaining the field the borrower is populating.

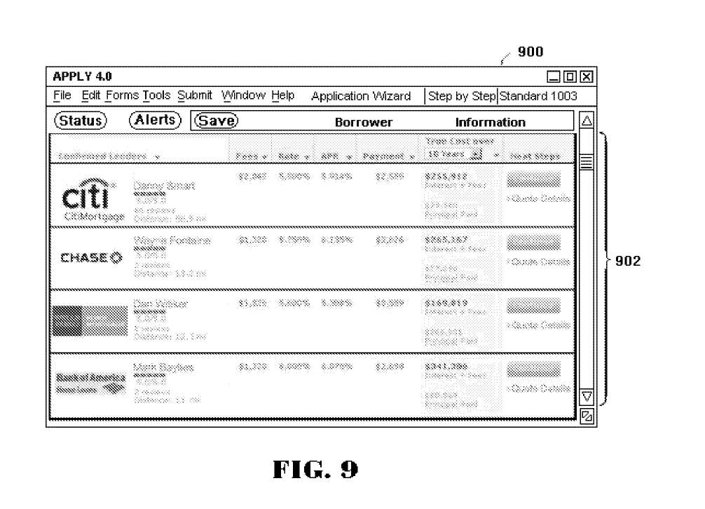

FIG. 9 illustrates an embodiment of the interface for the loan application process. This interface is implemented in such a way that the lenders are displayed to the borrower in a list allowing the borrower to choose which lender to do business with.

Underwriting Engine

The present disclosure has been described primarily in relation to loan applications for home mortgage loans.

As illustrated in FIG. 3, the loan origination and processing server contains an underwriting engine component 306. This component represents a core component of the system and is responsible for performing the loan application underwriting evaluation lender requirements and provided for generating a decision matrix based on user input of personal and financial data.

In one embodiment, the automated underwriting engine is, with respect to the loan application data, the underwriting entity that calculates the various different financial values that are related to the loan application based on the user provided data. The user is typically asked to provide a loan amount, loan term, and down payment amount. The underwriting engine then calculates monthly payment amounts, cost of loan, and other values that are of interest to the borrower.

Process for Loan Application

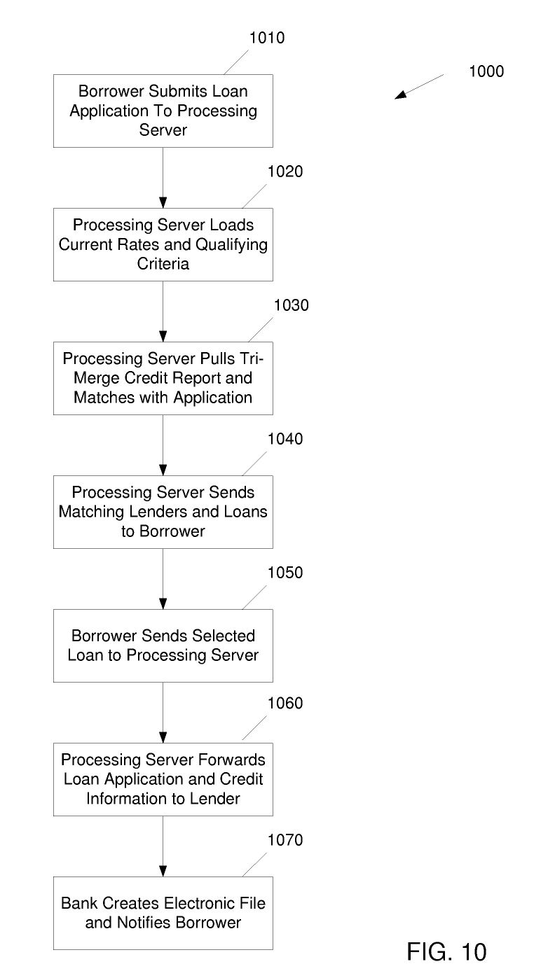

Referring now to FIG. 10, another flowchart 1000 that illustrates the steps undertaken by the loan originator, for a loan application processed by the system of FIG. 3, is shown. Flowchart 1000 is similar to that of the flowchart 400 shown in FIG. 4, except that additional details are provided.

The loan application is completed electronically on the borrower computer. As previously noted, this is typically a standard residential 1003 mortgage application. The completed loan application is submitted electronically by the borrower to the processing server, step 1010.

The processing server, at periodic intervals, requests updated rates and qualification criteria from a plurality of financial institutions, step 1020. For example, for each loan type, the processing server can obtain the rate and necessary loan qualifications from a lender.

Next, the processing server requests a Tri-Merge credit report for the credit reporting agencies. The Tri-Merge credit report is matched with the loan application, step 1030. The processing server then identifies those lenders and particular loans for which the borrower qualifies. The matches are then sent electronically back to the borrower, step 1040.

The borrower then reviews and accepts a loan from the list of matching loans. The acceptance of the loan is sent electronically back to the processing server, step 1050. The processing server thereupon electronically sends the loan application, Tri-Merge credit report, and information about the selected loan to the respective lender, step 1060.

Finally, the lender receives the information, creates an electronic file for the borrower, and notifies the borrower of the specific information associated with the requested loan, step 1070.

Although embodiments of the present disclosure have been described with reference to a network implementation comprising the Internet and Internet-related web browsing and web serving technologies, let it be noted that alternative embodiments of the present disclosure can be implemented on many other types of networks and network protocols, such as proprietary protocols for local area networks, wide area networks, and any combination thereof.

In the foregoing, a system has been described for processing and submitting loan applications through an embedded loan origination and processing software system interface. Although the present disclosure has been described with reference to specific exemplary embodiments, it will be evident that various modifications and changes may be made to these embodiments without departing from the broader spirit and scope of the disclosure as set forth in the claims. Accordingly, the specification and drawings are to be regarded in an illustrative rather than a restrictive sense.

What is claimed is:

1. A loan qualification system enabling a borrower to process a loan application, the system comprising:
one or more processors; and
memory storing instructions that, when executed by the processors, cause the processors to:
create a loan qualification program for the borrower; and
create an automated underwriting program storing lender data and loan data in a database coupled to the loan qualification program, the automated underwriting program matching borrower data and loan data to lender qualifying criteria and communicating one or more qualifying loan programs to the loan qualification program for display to the borrower.

2. The system of claim 1, wherein the loan qualification program connects a client computer to one or more lenders to enable direct submission of loan applications.

3. The system of claim 1, wherein the loan qualification program includes a web-based interface system.

4. The system of claim 1, wherein the loan qualification program is operable to display forms comprising a loan qualification application.

5. The system of claim 4, wherein the loan application allows the borrower to populate borrower data in the loan qualification application.

6. The system of claim 5, wherein the loan qualification program further stores administrative rules dictating population of the borrower data within the loan qualification application.

7. The system of claim 1, wherein the borrower is connected to one or more lender computers via an intermediate server computer to enable direct submission of a loan qualification application.

8. A computer program medium storing computer executable instructions, execution of the computer executable instructions by a computer causing the computer to:
create a loan qualification program for a borrower; and
create an automated underwriting program storing lender data and loan data in a database coupled to the loan qualification program, the automated underwriting program matching borrower data and loan data to lender qualifying criteria and communicating one or more qualifying loan programs to the loan qualification program for display to the borrower.

9. The computer program medium of claim 8, wherein the loan qualification program connects a client computer to one or more lenders to enable direct submission of loan applications.

10. The computer program medium of claim 8, wherein the loan qualification program includes a web-based interface system.

11. The computer program medium of claim 8, wherein the loan qualification program is operable to display forms comprising a loan qualification application.

12. The computer program medium of claim 11, wherein the loan qualification application allows the borrower to populate borrower data in the loan qualification application.

13. The computer program medium of claim 12, wherein the loan qualification program further stores administrative rules dictating population of the borrower data within the loan qualification application.

14. The computer program medium of claim 8, wherein the borrower is connected to one or more lender computers via an intermediate server computer to enable direct submission of a loan qualification application.

15. A method for a borrower to prepare and submit a loan qualification application, the method comprising:
initiating the loan qualification application on the borrower's computer;
completing the loan qualification application;
obtaining a credit report;
submitting the loan qualification application and the credit report electronically to an underwriting process;
receiving one or more qualifying loan programs to the borrower;
allowing selection of one of the qualifying loan programs; and
connecting to a lender associated with the selected qualifying loan program.

16. The method of claim 15, further comprising connecting the borrower to one or more lenders to enable direct submission of the loan qualification application.

17. The method of claim 15, wherein the loan qualification application includes a web-based interface system.

18. The method of claim 15, wherein a loan qualification program is operable to display forms comprising the loan qualification application.

19. The method of claim 18, wherein the loan qualification program allows the borrower to populate borrower data in the loan qualification application.

20. The method of claim 19, further comprising applying administrative rules dictating population of the borrower data within the loan qualification application.
